(19) United States
(12) Patent Application Publication
(10) Pub. No.: US 2014/0140604 A1
(43) Pub. Date: May 22, 2014

(54) METHOD FOR PROCESSING DUAL-ENERGY RADIOLOGICAL IMAGES

(71) Applicant: GENERAL ELECTRIC COMPANY, Schenectady, NY (US)

(72) Inventors: Ann-Katherine Carton, Rue de la Miniere (FR); Giovanni Palma, Rue de la Miniere (FR); Sylvie Puong, Rue de la Miniere (FR); Razvan Iordache, Rue de la Miniere (FR); Serge Muller, Rue de la Miniere (FR)

(21) Appl. No.: 14/084,253

(22) Filed: Nov. 19, 2013

(30) Foreign Application Priority Data
Nov. 19, 2012 (FR) 1260967

(51) Int. Cl. G06T 3/00

(52) U.S. Cl. CPC G06T 3/00
USPC 382/132

(57) ABSTRACT

A method for processing radiological images of a region of interest in a patient, the method comprising obtaining a set of images of the region of interest comprising at least two images, acquired using a medical imaging system, each image of the set of images being acquired at one X-ray energy, determining at least one recombined image by recombining a plurality of images forming a sub-set of images of the set of images for each recombination, segmenting at least one image from among the set of images, to detect and isolate at least one zone of the region of interest, and merging with the at least one recombined image whereby the at least one zone of the region of interest derived from segmentation is merged so as to visualize the at least one zone in the recombined image.

### FIELD OF THE INVENTION

Embodiments of the present invention relate to medical imaging and, more particularly, to multi-energy imaging.

### BACKGROUND OF THE INVENTION

Multi-Energy imaging entails the acquiring of images of one same anatomy with X-rays of different energies.

By recombining the images acquired at different energies, recombined images can be obtained which make use of the attenuation properties of the different imaged materials.

Images having different energies of regions in which a contrast product has been injected can provide functional information and in some cases allow the improved detection of abnormal vascular developments and lesions.

Multi-energy imaging is notably used in mammography and in some cases allows the improved detection and characterization of breast cancers.

Dual energy imaging is a particular case of multi-energy imaging. In dual energy X-ray imaging of the breast with injection of a contrast product (Dual-energy contrast-enhanced spectral x-ray imaging of the breast), pairs of low energy and high energy images of the breast are acquired after injecting a contrast product.

With multi-energy imaging it is therefore possible to obtain morphological and functional information on tissues and lesions in the breast region.

Morphological information can be provided by low energy images—i.e. the energy used in conventional mammography—whilst functional information is provided by the recombined images, in this case the dual energy images possibly improved with a contrast product These recombined images are produced by recombining the images of different energies, for example of low energy and high energy.

One advantage of multi-energy imaging is that it simultaneously enables the providing of morphological and functional data to allow the integration of the two types of data and thereby improve the diagnosis of cancer.

As is known, during surgical procedure, the recombined images and the low energy images are displayed side by side.

One problem is that, when displayed separately, the linking between the data shown in the two images must be performed mentally by the radiologist.

This is not problem-free since it may lead to inaccurate interpretations: in particular, the matching of the two images is difficult and may therefore lead to a wrong diagnosis.

### BRIEF DESCRIPTION OF THE INVENTION

Embodiments of the present invention allow the merging of the data derived from images of different energies to facilitate subsequent interpretation thereof.

For this purpose, an embodiment of the present invention proposes a method for processing radiological images of a region of interest in a patient, the method comprising the following steps: obtaining a set of images of the region of interest comprising at least two images of the region of interest, the set of images being acquired using a medical imaging system, each image in the set of images being acquired at one X-ray energy; determining at least one recombined image by recombining a plurality of images forming a sub-set of images of the set of images for each recombination; segmenting at least one image from among the set of images, to detect and isolate at least one zone of the region of the interest; and merging with the at least one recombined image, consisting of merging the at least one zone of the region of interest derived from segmentation in order to visualize said zone in the recombined image.

Embodiments of the present invention are advantageously completed by the following characteristics, taken alone or in any of their combinations:

In an embodiment, the images of the sub-set of images are acquired at different energies.

In an embodiment, the recombined image is a dual energy image.

In an embodiment, the segmented images merged with each recombined image are derived from the sub-set of images associated with this recombined image.

In an embodiment, the merging step comprises a step to scale the contrasts of the zone in the recombined image, using the differences in contrast in a vicinity of the detected zone.

In an embodiment, a first series of projection images is obtained and a second series of projection images, the images in each series corresponding to projections at different angle positions, in order to construct a merged three-dimensional image.

In an embodiment, after the segmenting step, a step to reconstruct a three-dimensional image of the detected, isolated zone.

In an embodiment, before the segmenting step, a step to reconstruct a three-dimensional image, the segmenting step being applied to the three-dimensional image.

In an embodiment, the set of images is derived from images previously acquired and recorded.

An embodiment of the present invention also concerns a system comprising a processing unit including means to implement the processing method of the present invention.

An embodiment of the present invention also concerns a computer program product comprising program code instructions to perform the steps of the method of the present invention, when it is executed on a computer.

The advantages of embodiments of the present invention are multiple. The present invention allows a presentation of morphological and functional data grouped together and therefore integrates the forces of the two types of data. The invention particularly allows the presenting of this data, the locating thereof in the region of interest and the inter-relating thereof with extensive positioning accuracy.

Since the present invention can be carried out using a computer program product and is able to be implemented on existing imaging systems, it is easy and low-cost to set up.

In particular, for mammography imaging techniques, the present invention allows the grouping together of data on lesions enhanced by a contrast product and microcalcifications in a single image. Since the elements are indicative of the presence or absence of cancer, the invention allows easier, more precise analysis of radiological images. With the invention it is therefore possible to facilitate and improve cancer diagnosis.

The present invention can be applied to mammography but also to other dual-energy imaging techniques.

### BRIEF DESCRIPTION OF THE DRAWINGS

Other characteristics and advantages of the present invention will become apparent from the description given below of embodiments. In the appended drawings:

FIGS. 1 and 2 schematically illustrate examples of medical imaging systems according to embodiments of the present invention;

FIGS. 3 and 4 schematically illustrate steps of a method according to an embodiment of the present invention.

### DETAILED DESCRIPTION OF THE INVENTION

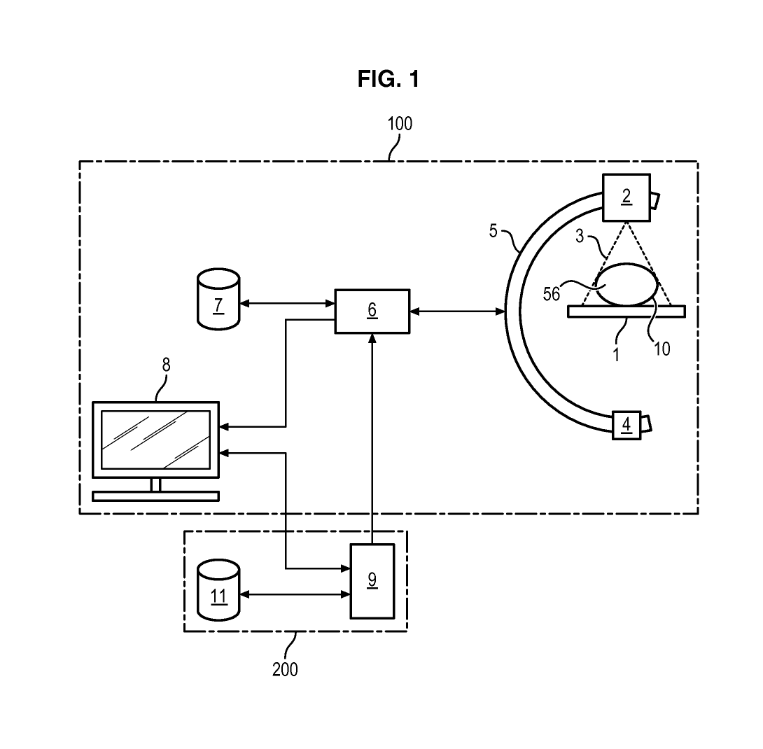

FIG. 1 schematically illustrates a medical imaging system 100 for acquiring radiological images.

The medical imaging system 100 comprises a support 1 intended to receive a patient 10 to be examined, a source 2 intended to emit a beam 3 of X-rays, a detector 4 arranged facing the source 2 and configured to detect the X-rays emitted by the source 2, a control unit 6, a storage unit 7 and a display unit 8.

The X-ray source 2 and the detector 4 are connected by a C-shaped arm 5. Said arm 5 is known as a C-arm. Said arm 5 can be oriented over three degrees of freedom.

The detector 4 may be a semiconductor image sensor for example comprising caesium iodide phosphor (scintillator) on a transistor/photodiode array in amorphous silicon. Other suitable detectors are: a CCD sensor, direct digital detector which directly converts the X-rays to digital signals. The detector 4 illustrated in FIG. 1 is planar and defines a planar imaging surface. Other geometries may evidently be suitable.

The control unit 6 is connected to the C-arm 5 via a wire or wireless connection. The control unit 6 is used to control image acquisition by setting several parameters such as the radiation dose to be emitted by the X-ray source and the angle positioning of the C-arm 5. The control unit 6 allows the controlling of the position of the C-arm 5 i.e. the position of the source 2 relative to the detector 4.

The control unit 6 may comprise a read device (not illustrated) e.g. a disk drive, a CD-ROM, DVD-ROM drive or connection ports to read the instructions of the method from an instruction medium (not illustrated) such as a disk, a CD-ROM, DVD-ROM, or USB flash drive or more generally any removable memory medium or even via a network connection.

The storage unit 7 is connected to the control unit 6 to record parameters and acquired images. It is possible to make provision so that the storage unit 7 is located inside or outside the control unit 6. The storage unit 7 may be formed of a hard disk or SSD, or any other removable, re-write storage means (USB flash drives, memory cards, etc.). The storage unit 7 may be a ROM/RAM memory of the control unit 6, a USB flash drive, a memory card or a memory of a central server.

The display unit 8 is connected to the control unit 6 to display the acquired images and/or data on the parameters for controlling acquisition. The display unit 8 may be a computer screen for example, or a monitor, flat screen, plasma screen or any type of known display device. Said display unit 8 enables a practitioner to monitor the acquisition of the radiological images.

The medical imaging system 100 is coupled to a processing system 200. The processing system 200 comprises a computing unit 9 and a storage unit 11. The processing system 200 receives the images acquired and stored in the storage unit 7 of the medical imaging system 100, on the basis of which it performs a certain number of processing operations (see below).

The transmission of data from the storage unit 7 of the medical imaging system 100 to the computing unit 9 of the processing system 200 can be made via an internal or external computer network using any suitable physical memory medium such as disks, CD-ROM, DVD-ROM, external hard disk, USB flash drive, SD card, etc.

The computing unit 9 may for example be one or more computer(s), processor(s), microcontroller(s), microcomputer(s), programmable logical controller(s), application-specific integrated circuit(s), other programmable circuits, or other devices including a computer such as a work station.

As a variant, the computing unit 9 may comprise a read device (not illustrated) e.g. a disk drive, CD-ROM or DVD-ROM drive, or connection ports to read the instructions of the processing method from an instruction medium (not illustrated) such as a disk, CD-ROM, DVD-ROM or USB flash drive or more generally any removable storage medium or even via a network connection.

In addition, the processing unit comprises a storage unit 11 for storing the data generated by the computing unit 9. Further, the computing unit 9 can be connected to the display unit 8 or else to another display unit (not illustrated).

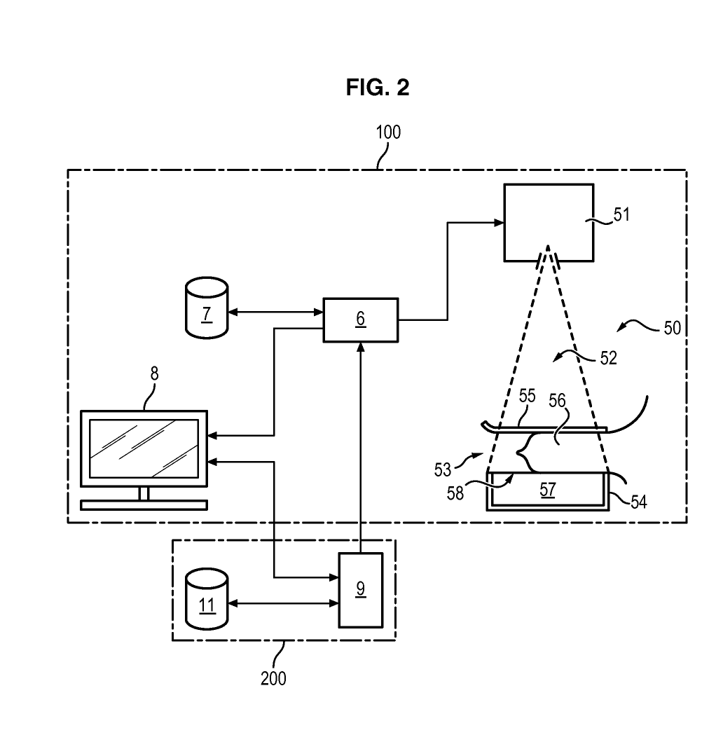

FIG. 2 schematically illustrates a medical imaging system 100 for acquiring images by mammography. This medical imaging system 100 differs from the medical imaging system previously described in that the control unit 6 is connected to mammography apparatus 50 instead of to the C-arm in FIG. 1.

The mammography apparatus 50 comprises an X-ray source 51 capable of emitting a beam 52 of X-rays towards a support 53 comprising a lower block 54 on which a patient's breast 56 is positioned and an upper plate 55 called the compression paddle. The upper plate 55 is mobile in vertical translation to allow compressing of the patient's breast 56 against the lower block 54.

The lower block 54 further comprises a detector 57 whose detection surface 58 is directed towards the beam 52, directly underneath the breast 56. The X-ray beam 52 emitted by the source 51 encounters the patient's breast 56, and the detector 57 then captures the X-rays transmitted by the breast 56 to form a mammographic image.

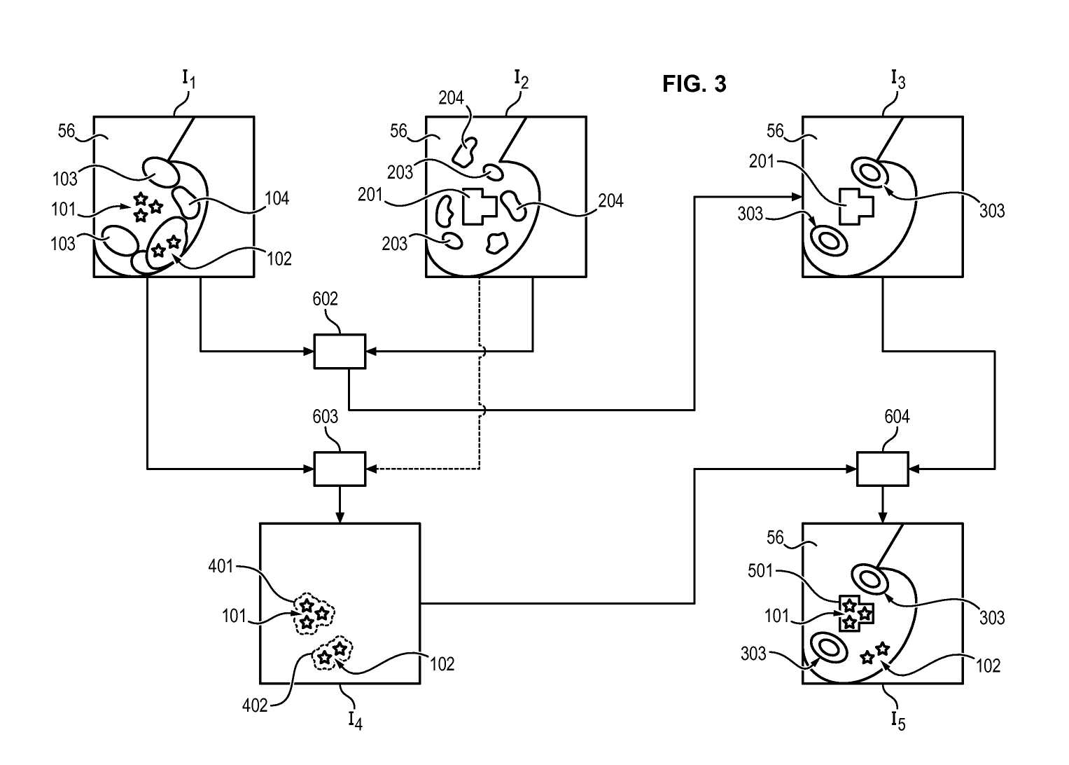

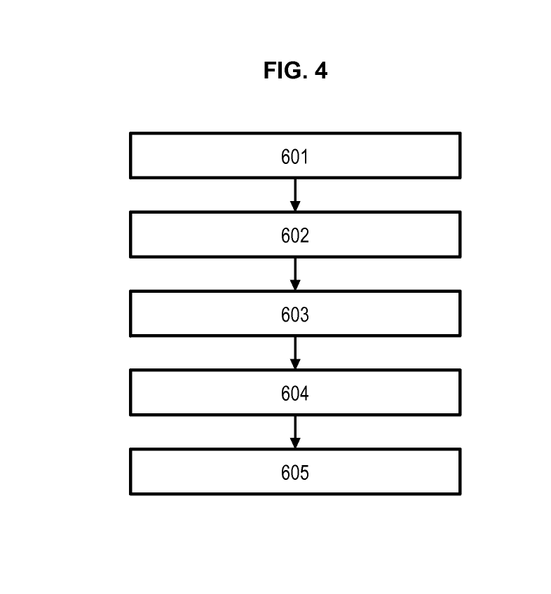

With reference to FIG. 3, a method is described for processing radiological images conforming to one embodiment of the invention. The steps of the method are schematically illustrated in FIG. 4. The method concerns the processing of radiological images of a region of interest 56 in a patient 10. A contrast product may previously have been injected into the region of interest 56.

Said method is carried out in a computing unit of a medical imaging system 100. The medical imaging system 100 corresponds for example to one of the systems described in the foregoing and illustrated in FIGS. 1 and 2. In the example illustrated in FIG. 3, the images are obtained with a medical imaging system 100 for acquiring images by mammography.

In at least one embodiment, the term image means a representation which may be two-dimensional or three-dimensional. An image can therefore be a three-dimensional representation of a volume. Said image may comprise a series of representations in accordance with set modalities.

The method comprises a first step 601 to obtain a set of images of a region of interest 56 comprising at least two images I₁ and I₂ of the region of interest 56.

The set of images, and in particular the two images I₁ and I₂ are acquired by means of the medical imaging system 100. The set of images may derive from images previously acquired and recorded. The first image I₁ and the second image I₂ may derive from images previously acquired and recorded.

Multi-energy medical imaging entails the acquiring of images of one same anatomy using X-rays of different energies.

Said imaging protocol allows for taking advantage of the attenuation properties of the different imaged materials; human tissue, instruments used for interventional radiology, etc.

The first step 601 and the method as a whole are described herein with particular reference to two images. The entire method can easily be generalized to multi-energy imaging involving more than two images. The entire method can also be easily generalized to more than two images or to series of images.

Since multi-energy is used for acquiring the images, the first image 11 is acquired at a first energy of the X-rays, the second image I₂ being acquired at a second X-ray energy different from the first X-ray energy. For example, the first image I₁ is a low energy image and the second image I₂ is a high energy image. Each image of the set of images is acquired at one X-ray energy.

In an embodiment, the two images I₁ and I₂ are acquired at different energies so that there is no significant movement of the region of interest between these two images I₁ and I₂.

In dual energy X-ray imaging of the breast with injection of a contrast product, the low energy is generally between 17 and 22 keV, and the high energy is generally between 32 and 35 keV.

Since the two images are derived from acquisitions at different X-ray energies, the first and the second image allow different elements to be visualized.

In multi-energy imaging, a material is characterized by the variability of its absorbance as a function of the energy of the emitted radiation. Alvarez, Macovski, Lehmann et al.: “Generalized image combinations in dual KVP digital radiography”; L. A. Lehmann, R. E. Alvarez, A. Macovski, W. R. Brody, N. J. Pelc, S. J. Riederer, and A. L. Hall, Med. Phys. 8, 659 (1981), OI:10.1118/1.595025) have shown that the linear attenuation μ of a material can be expressed as a linear combination of two functions dependent on energy E:

μ=ac fc(E)+ap fp(E)

The two constants ac and ap characterize the material, and depend in particular on atomic number Z, and on the mass of the material. Depending on the desired effect therefore, energies will be chosen which attenuate and/or preserve different human tissues.

In dual energy imaging, the high energy image allows the visualization of some elements represented by zones of particular contrast. The low energy image allows the visualization of other elements represented by zones of particular contrast.

The contrast zones are not necessarily the same between the two images since they were obtained at different energies enhancing different materials.

The first image I₁ of the region of interest 56 shows different elements. For example, with reference to FIG. 3, in the first image I₁ different zones 101, 102, 103, 104 can be seen.

The zones 101, 102 may be microcalcification zones; the zones 103, 104 may be masses.

The second image I₂ of the region of interest 56 shows other elements.

With reference to FIG. 3, in the second image I₂ different zones 201, 203 and 204 can be visualized. The zones 201, 203 and 204 may be masses.

Alternatively to the embodiment shown in FIG. 3, the medical imaging system 100 may be a medical imaging system for acquiring images by tomosynthesis. This may be a medical imaging system 100 such as shown in FIG. 1. With said system, it is possible to obtain a three-dimensional image of a region of interest in the form of a series of successive slices.

The method for processing radiological images is then applied to a plurality of pairs each formed of a first projection image acquired at a first energy and of a second projection image acquired at a second energy. Each pair corresponds to a 2D projection in one direction e.g. an angular orientation identified relative to the perpendicular to the support 1. The so-called zero orientation is defined as being the one the closest to the perpendicular to the plate 1.

Using the sets of projection images acquired at each energy, it is possible to reconstruct a three-dimensional image or three-dimensional representation i.e. a reconstructed volume for each of the two energy levels.

The method comprises a second step 602 to determine at least one recombined multi-energy image I₃ by recombining a plurality of images forming a sub-set of images of the set of images for each recombination, for example by recombining the first image I₁ acquired at the first energy with the second image I₂ acquired at the second energy.

This recombination is in the form for example of:

I₃=α log I₁+β log I₂

where α and β are constants. The constants can be determined as a function of the physical characteristics of a constituent material of elements which it is desired to cause to disappear or to enhance.

The recombined image I₃ may be a specific image of any material, for example a contrast product which may be present in the imaged breast.

In breast imaging, this recombination may comprise a function of the acquired images, for example the first image I₁ and the second image I₂, whose form is determined so that the recombined image I₃ contains data related for example to the thickness of some elements of the breast or to the composition of the breast.

Other recombination methods are possible. For example reference may be made to the document by Sylvie Puong: “Imagerie du sein multi spectrale avec produit de contraste” (Multi-spectral breast imaging with contrast product—Doctoral thesis 2008), which is incorporated herein by reference and describes several recombination methods in multi-energy imaging.

This determination step 602 by recombination does not involve degradation of the recombined image I₃. On the other hand, it does allow the deletion of some elements.

For example, in FIG. 3, it allows deletion of the masses 104 and the masses 204.

The elements corresponding to morphological data such as microcalcifications 101 and 102 are deleted.

The elements 201 and 303 in the recombined image I₃ correspond to functional data. These may be elements resulting for example from the diffusion of a contrast agent inside lesions.

The elements 303 represent the zones in which the masses 103 and the masses 203 are superimposed. The masses 201 are also maintained.

The multi-energy image can be obtained by recombining more than two images. These images can be acquired using more than two different energies.

The method comprises a third step 603 to segment at least one image from among the set of images, to detect and isolate at least one zone of the region of interest 56. For example, this may entail segmenting in the first image I₁ or in the second image I₂ or in both to detect and isolate at least one zone of the region of interest 56.

The segmentation 603 may comprise a step to select at least one zone of the region of interest 56 present in the first image I₁ or in the second image I₂.

The zone may represent at least one microcalcification. For example in FIG. 3, it represents microcalcifications 101 and 102.

When analyzing mammographic images, it is important to maintain morphology, the contrast of the grey scale and the spatial arrangement of microcalcifications 101 and 102. The microcalcifications 101 and 102 are effectively important discriminating factors for the presence of absence of breast cancer.

At step 603, for example, the microcalcifications 101 and 102 are automatically detected and segmented in the first low energy image I₁ using a CAD tool (Computer aided detection/diagnosis). The CAD tool is based on algorithms such as filtering and thresholding methods. Other methods related to mathematical morphology, neuronal networks, stochastic models or approaches based on contours can be used when implementing the CAD tool. One example of the use of a CAD tool is given by Sylvain Bernard, Serge Muller, Jon Onativia, “Computer-Aided Microcalcification Detection on Digital Breast Tomosynthesis Data: A Preliminary Evaluation”, Digital Mammography, Studies in Fuzziness and Soft Computing Volume 210, pp 293-323, the contents of which are incorporated herein by reference.

After the segmenting step 603, a segmented image I₄ is obtained representing the detected and isolated zone. This image I₄ is, in an embodiment, of the same size as the first and second images I₁ and I₂.

In FIG. 3, the segmented image I₄ shows the microcalcifications 101 and 102.

A vicinity 401, respectively 402, of the microcalcifications 101, respectively 102, is also shown. The segmented image I₄ therefore comprises data related to the microcalcifications 101 and 102, and to their spatial position, but also data on a vicinity of the microcalcifications 101 and 102, in particular on the contrasts of the grey scale in the vicinity of the microcalcifications 101 and 102.

For images derived from a medical imaging system 100 for acquiring images via CESM (Contrast enhanced spectral mammography) which may be such as those in FIG. 3, the detection and segmentation at step 603 can be performed only in the first low energy image I₁, only in the second high energy image I₂ or in both combined.

For images derived from a medical imaging system 100 for acquiring images via CE-DBT (contrast enhanced digital breast tomography), projection images taken at different angle positions are recorded and then used to form a reconstructed image. It is thus possible to obtain a first, respectively a second series of projection images I₁ and I₂ respectively. Through the use of several of these projection images I₁ and I₂ respectively, it is possible respectively to obtain a first and a second three-dimensional representation or a respective reconstructed volume J₁ and J₂. Each reconstructed volume J₁ or J₂ may comprise images of successive slices of the region of interest 56.

The detection and segmentation, according to a first option, can then be performed only in the first series of projection images I₁ or only in the second series of projection images I₂, or according to a second option in the first series of projection images I₁ in combination with the second series of projection images I₂.

Alternatively, according to a third option, the detection and segmentation can be performed only in the first reconstructed volume J₁ or only in the second reconstructed volume J₂ or, according to a fourth option, in the first reconstructed volume J₁ in combination with the second reconstructed volume J₂.

Another possibility, according to a fifth option, is to carry out detection and segmentation using: firstly, the first series of projection images I₁ or the second series of projection images I₂; and the first reconstructed volume J₁, associated for example with a low energy, or the second reconstructed volume J₂, associated for example with a high energy.

According to a sixth option: the first series of projection images I₁ and the second series of projection images I₂ are used in combination with the first reconstructed volume J₁ or the second reconstructed volume J₂.

According to a seventh option, the detection and segmentation use: firstly, the first series of projection images I₁ and the second series of projection images I₂; and secondly, the first reconstructed volume J₁ and the second reconstructed volume J₂.

In an eighth option, use is made of: firstly, the first series of projection images I₁ or the second series of projection images I₂; and secondly, the first reconstructed volume J₁ and the second reconstructed volume J₂.

The method comprises a fourth step 604 to merge the at least one recombined image I₃ obtained after step 602. The fourth merging step 604 entails the merging in a merged image I₅ of the zone of the region of interest 56 derived from the third segmentation step 603 to visualize said at least one zone in the recombined image I₃. Therefore data provided by the segmented zone and data provided by the recombined image I₃ are grouped together to produce a single set.

With reference to FIG. 3, a merged image I₅ is obtained resulting from the merging of the recombined image I₃ and of the microcalcifications 101 and 102 derived from the segmented image I₄.

The correction step 604 comprises a step to scale contrasts of the correction zone in the recombined image I₃ from signal differences in the vicinity of the detected zone. This may entail the scaling of contrasts on the basis of signal differences in the vicinity of the detected zone, in the first image I₁ and/or the second image I₂.

With reference to FIG. 3, the vicinities 401 and 402 shown in the segmented image I₄ contain data allowing the scaling of the contrasts of the correction zone comprising the microcalcifications 101 and 102.

Since the recombined image I₃ and the segmented image I₄ share the same imaging modalities, such as format, size or positioning of the elements, it is possible to obtain a merged image I₅ having very precise positioning.

In the case illustrated in FIG. 3, images derived from medical imaging systems 100 for the acquisition of images via CESM, the segmented microcalcifications 101 and 102 in the segmented image I₄ are therefore merged with the recombined image I₃ to obtain the merged image I₅.

For images derived from medical imaging systems 100 for the acquisition of images via CE-DBT, the segmented zone according to the first and second option and the recombined projection image I₃ are merged. A merged reconstructed volume J₅ is therefore obtained from several merged projection images using a tomographic reconstruction algorithm.

Alternatively segmented images I₄ comprising the segmented zone, according to the first or second options, are used to obtain a reconstructed volume of the segmented zone. It is then possible to process any artefacts in the reconstructed volume of the segmented zone. The reconstructed volume of the segmented zone is then merged with a reconstructed and then recombined volume, or with a volume reconstructed from recombined projection images.

According to another possibility, the segmented zone according to the third option or fourth option is merged with a reconstructed then recombined volume, or with a volume reconstructed from recombined projection images.

According to an additional possibility, the segmented zone according to the fifth option, the sixth option, the seventh option or the eighth option is merged with a series of recombined projection images. A reconstructed merged volume is then obtained from the projection images thus merged using a tomographic reconstruction algorithm.

Alternatively, the segmented zone according to the fifth option, the sixth option, the seventh option or the eighth option is merged with a reconstructed then recombined volume, or with a volume reconstructed from recombined projection images.

According to one example of embodiment, the segmented images merged with each recombined image are derived from the sub-set of images associated with this recombined image.

The method comprises a fifth step 605 to display the merged image I₅ on a display unit. This may be a display unit 8 of the medical imaging system 100 or another display unit.

The merged image I₅ groups together the morphological and functional data relating to multi-energy imaging.

In FIG. 3, the image I₅ allows the differentiating between the microcalcifications 101 which are included in a merged mass 501 corresponding to the mass 201 in the recombined image I₃, and the microcalcifications 102 which are not included. The morphological information corresponding to the microcalcifications 101 is therefore merged with the functional information corresponding to the merged mass 501.

The above-described processing method can be carried out by a computer program product comprising program code instructions executable by computer, processor and/or controller, that when executed by said computer, processor and/or controller, perform some or all of the steps of the above-described method. The program code instructions are stored on a non-transitory computer-readable medium.

1. A method for processing radiological images of a region of interest in a patient, the method comprising the following steps:
obtaining a set of images of the region of interest comprising at least two images of the region of interest, the set of images being acquired using a medical imaging system, each image of the set of images being acquired at one X-ray energy;
determining at least one recombined image by recombining a plurality of images forming a sub-set of images of the set of images for each recombination;
segmenting at least one image from among the set of images, to detect and isolate at least one zone of the region of interest; and
merging with the at least one recombined image whereby the at least one zone of the region of interest derived from segmentation is merged in order to visualize the at least one zone in the recombined image.

2. The method according to claim 1, wherein the images of the subset- of images are acquired at different energies.

3. The method according to claim 1, wherein the segmented images merged with each recombined image are derived from the sub-set of images associated with this recombined image.

4. The method according to claim 1, wherein the merging step comprises a step to scale the contrasts of the zone in the recombined image using the differences in contrast in a vicinity of the detected zone.

5. The method according to claim 1, wherein a first series of projection images is obtained and a second series of projection images, the images of each series corresponding to projections at different angle positions so as to construct a merged three-dimensional image.

6. The method according to claim 1, further comprising after the segmentation step, a step to reconstruct a three-dimensional image of the detected and isolated zone.

7. The method according to claim 5, further comprising, before the segmentation step, a step to reconstruct a three-dimensional image, the segmentation step being applied to the three-dimensional image.

8. The method according to claim 1, wherein the set of images is derived from images previously acquired and recorded.

9. A medical imaging system comprising :
a processing unit or computer configured to process radiological images of a region of interest in a patient and, in processing the images, is configured to:
obtain a set of images of the region of interest comprising at least two images of the region of interest, the set of images being acquired using a medical imaging system, each image of the set of images being acquired at one X-ray energy;
determine at least one recombined image by recombining a plurality of images forming a sub-set of images of the set of images for each recombination,
segment at least one image from among the set of images, to detect and isolate at least one zone of the region of interest; and
merge with the at least one recombined image whereby the at least one zone of the region of interest derived from segmentation is merged in order to visualize the at least one zone in the recombined image.

10. A non-transitory, computer-readable medium storing program code instructions executable by a computer processor to perform a method, the method comprising:
obtaining a set of images of the region of interest comprising at least two images of the region of interest, the set of images being acquired using a medical imaging system, each image of the set of images being acquired at one X-ray energy;
determining at least one recombined image by recombining a plurality of images forming a sub-set of images of the set of images for each recombination;
segmenting at least one image from among the set of images, to detect and isolate at least one zone of the region of interest; and
merging with the at least one recombined image whereby the at least one zone of the region of interest derived from segmentation is merged in order to visualize the at least one zone in the recombined image.
